(19) United States
(12) Patent Application Publication
(10) Pub. No.: US 2011/0088223 A1
(43) Pub. Date: Apr. 21, 2011

(54) Reversible wire clip with multiple clipping effects

(76) Inventor: Tod Michael O'Daniel, Thousands Oaks, CA (US)

(21) Appl. No.: 12/589,247

(22) Filed: Oct. 21, 2009

(51) Int. Cl. B42F 1/04; A44B 99/00

(52) U.S. Cl. 24/67.9; 24/570

(57) ABSTRACT

An improved clip formed of a pre-determined length of wire providing reversibility from at least two opposing directions with a plurality of clipping effects, and means for a plurality of substantially different holding power strengths to at least one amount of sheet material, is what the present patent is about (FIG. 5A-FIG. 5C). Although instructing spring loading (FIG. 13A-FIG. 13C), not spring loading an embodiment is also satisfactory. In one embodiment, one spline (24) provides torsion resulting in a strong holding power in one clipping effect (FIG. 5A). In another clipping effect, from an opposite direction (FIG. 5C), one spline (26) provides torsion resulting in another strong holding power similar to the previous one. In a third clipping effect, from this same direction (FIG. 5B), two splines (26, 28) provide torsion resulting in an extra strong holding power for larger size amounts of sheet material for a given size clip. An embodiment may be rotated 360 degrees between two clipping effects on a material (FIG. 5C, FIG. 5A), and removed and reapplied from any direction at any time. An embodiment does not rotate in the other clipping effect (FIG. 5B). Nearly unlimited embodiments are possible, and some exemplary ones have been provided as basic, alien, symbol, animal, and cartoon character (FIG. 1A, FIG. 2A, FIG. 3A, FIG. 4A, FIG. 6, FIG. 7, FIG. 8, FIG. 9A, FIG. 10A, FIG. 10E, FIG. 10F, FIG. 11, FIG. 12).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This application relates to paperclips, money clips and all purpose clips.

2. Prior Art

Places of business, schools, homes, and anywhere paper or the like is used, people commonly have used wire clips for securing a plurality of such sheet material. Originally, wire clips were made as simple and as cheap as possible for economical reasons. The gem style clips are a perfect example of this, having only three bends. However, this type of clip lacks much capacity, and twists on even moderate sheet material amounts. This undesirable effect leaves the consumer with weak security at best. Also, bare wire ends are present which can tear documents.

Thereafter, several types of wire clips were designed to have increased capacity, and holding power. In 1920, U.S. Pat. No. 1,336,626 to Hall, disclosed an Ideal type clip for toy construction and has increased capacity. However, a small one is not made as a paper clip. This is probably because one, once deformed from use on too large amount of sheet material for a given size clip, is not easily fixed. Furthermore, a large one is too heavy for use on small amounts of sheet material. U.S. Pat. No. 2,061,474 to Metz (1935) discloses a reversible clip, claiming time saving features. This clip is most likely not around today because, the time saved is not worth the extra cost. Lewis, in 1936, came up with a bulldog type clip. U.S. Pat. No. 2,052,887 to him discloses a single plane clip with increased holding power on moderate to large amounts of sheet material for a given size clip. However, this type of design does not hold very small amounts of sheet material well, even with a moderately small size clip. This is probably why this type of clip is made only in a very small size today. U.S. Pat. No. 4,949,435 to Michelson (1990) discloses a cheaper ideal type clip with only one overlapping point. This one is probably not sold today because people want quality not quantity, and people already have Ideal type clips to choose from. U.S. Pat. No. 5,319,835 to Chao (1994) discloses a double clamping effect wire clip. However, like a bulldog type clip with only one clipping effect, this design does not function well on small sheet material amounts, unless in a very small size.

### SUMMARY

In accordance with one embodiment a clip provides reversibility from at least two opposing directions with a plurality of clipping effects, and means for a plurality of substantially different holding power strengths to at least one amount of sheet material.

### DRAWINGS—FIGURES

FIG. 1A shows The First Embodiment with portions and parts labeled.

FIG. 1B shows a side view of The First Embodiment with two substantial planes.

FIG. 2A shows The Second Embodiment with portions and parts labeled.

FIG. 2B shows a side view of The Second Embodiment and planar differences.

FIG. 3A shows The Third Embodiment with portions and parts labeled.

FIG. 3B shows a side view of The Third Embodiment and planar composition.

FIG. 4A shows The Fourth Embodiment with portions and parts labeled.

FIG. 4B shows a side view of the Fourth Embodiment and planar composition.

FIG. 5A shows a first clipping effect of The First Embodiment on a material M.

FIG. 5B shows a second clipping effect of The First Embodiment.

FIG. 5C shows a third clipping effect of The First Embodiment.

FIG. 6 is an example of a reverse overlapping point composition.

FIG. 7 shows a basic rounded embodiment.

FIG. 8 shows a basic reverse loop embodiment with end portion loops bending in reverse directions than the first embodiment.

FIG. 9A shows an alien embodiment front view.

FIG. 9B shows a side view of this alien embodiment.

FIG. 9C shows a middle portion as like a section of a coil spring.

FIG. 10A shows a music notes embodiment.

FIG. 10B shows a side view of this music notes embodiment with a two substantial plane composition.

FIG. 10C shows a difference in an application of this embodiment to a material M, and a clipping effect.

FIG. 10D shows another clipping effect of this embodiment to a material M and music notes symbol shown.

FIG. 10E shows a modified music notes embodiment with portions made square to each other.

FIG. 10F shows another music notes embodiment with overlapping point placement on a corner.

FIG. 10G shows a clipping effect of this embodiment with a tab left protruding for easy removal, or for document marking if colored.

FIG. 11 shows an animal head embodiment.

FIG. 12 shows a cartoon character embodiment made asymmetrically, and with more than one substantial loop on each end portion.

FIG. 13A shows a first step in making an embodiment with a level plane and a plumb plane.

FIG. 13B shows bringing of end portions 16Amcn, 16Bmcn just past each other enough to overlap and spring load.

FIG. 13C shows a resulting embodiment and overlapping point 14mcn in place.

### DRAWINGS—Reference Numerals

10 middle portion
12A adjacent portion
12B adjacent portion
14 overlapping point
16A end portion
16B end portion
18 entry angle
20 leg
22 leg
24 spline
25 bend
26 spline
27 bend
28 spline

The same is true with suffixes quad (four substantial plane), bis (two substantial plane), pi (three substantial plane), rnd (rounded adjacent portion), rvs (reverse loop), aln (alien), msc (music notes), smsc (squared music notes), tmsc (tabbed music notes), ctn (cartoon character), mcn (machine), rev (reverse overlapping point).

### DETAILED DESCRIPTION—FIRST EMBODIMENT—FIG. 1A, FIG. 1B

The overall structure of this embodiment is shown in FIG. 1A with middle portion 10 having an overall substantial U shape and including spline 24, leg 20, and leg 22. Adjacent portion 12A is connected to one end of middle portion 10. Adjacent portion 12B is connected to an opposite end of middle portion 10. Adjacent portion 12A (includes spline 26) bends inward, and Adjacent Portion 12B (includes spline 28) bends inward. Adjacent portions 12A and 12B overlap one another at overlapping Point 14 (FIG. 1A). Entry angle 18 formed by adjacent portions 12A and 12B overlapping one another, side to side, is approximately 45 degrees in this embodiment. Adjacent portion 12A continues past overlapping point 14 but does not extend past middle portion 10, and end portion 16A connects. End portion 16A forms a loop. Adjacent portion 12B continues past overlapping point 14 but does not overlap middle portion 10, and end portion 16B connects. End portion 16B forms a loop. End portion loops 16A, and 16B do not overlap middle portion 10 (FIG. 1A).

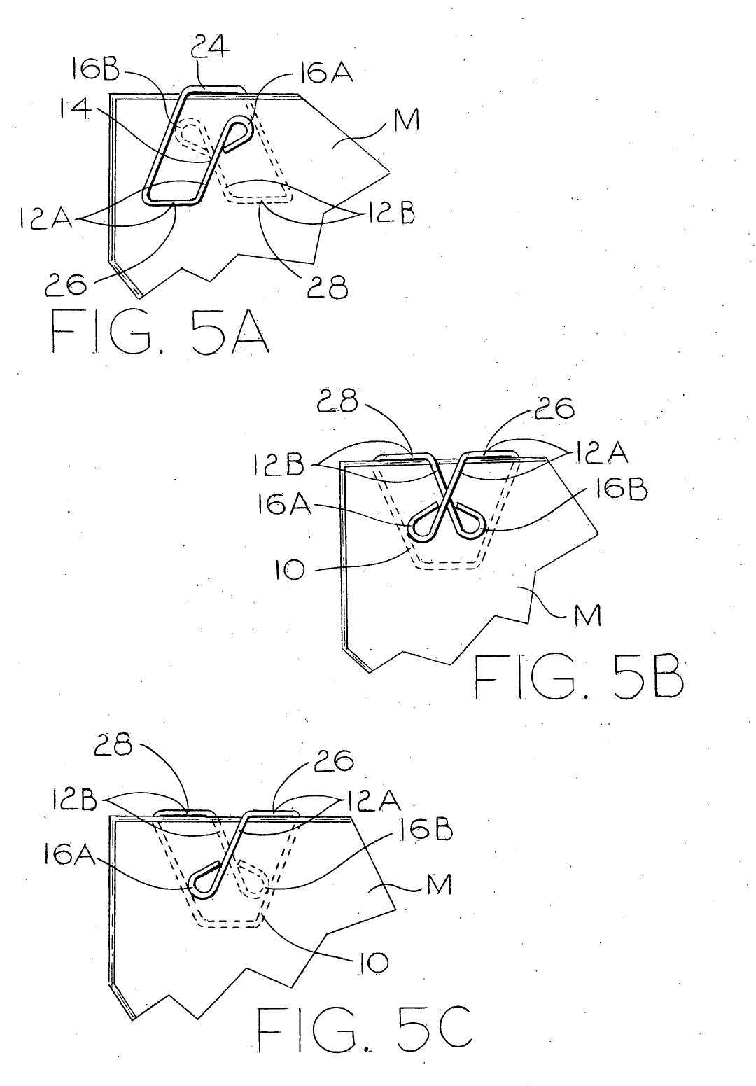

FIG. 1B shows adjacent portion 12A with end portion 16A being in plane with leg 20 and spline 24. These portions form a first substantial plane. Adjacent portion 12B with end portion 16B is in plane with leg 22 and spline 24. This forms a second substantial plane and makes a two substantial plane embodiment. The first substantial plane and the second substantial plane intersect and connect at spline 24. Leg 20, adjacent portion 12A, and end portion 16A are spring loaded against leg 22, adjacent portion 12B and end portion 16B. This is through spline 24. An embodiment not being spring loaded is also satisfactory, however, less powerful in clipping effects of FIG. 5A, FIG. 5C.

### Operation—The First Embodiment, FIG. 1A, FIG. 1B, FIG. 5A-FIG. 5C

Operation of an embodiment includes a plurality of clipping effects through applications from at least two opposing directions and to at least one sheet of material. FIG. 5A shows a first application from one direction of this embodiment to sheet material M whereby overlapping point 14 spreads to accept sheet material M edge during operator application. In this clipping effect, spline 24 provides torsion. Adjacent portion 12A (includes spline 26) and end portion 16A clamps against adjacent portion 12B (includes spline 28) and end portion 16B (FIG. 5A). This clipping effect provides a strong holding power and is applicable for a single sheet of sheet material through an amount of sheet material requiring full capacity for a given size clip. FIG. 5B shows a second clipping effect from an opposing direction of this embodiment to sheet material M. End portion 16A, end portion 16B, adjacent portion 12A and adjacent portion 12B spread away from mid portion 10 during application. These portions clip against mid portion 10 once applied (FIG. 5B). In this clipping effect, spline 26 and spline 28 provide torsion. An increasingly extra strong holding power is present on medium large amounts of sheet material through amounts requiring maximum capacity for a given size embodiment. FIG. 5C shows a third clipping effect from this direction to a sheet material. End portion 16A and adjacent portion 12A spread away from middle portion 10, adjacent portion 12B, and end portion 16B during application. End portion 16A and adjacent portion 12A clip against end portion 16B, adjacent portion 12B, and mid portion 10 once applied. In this clipping effect, spline 26 provides torsion. This clipping effect provides a strong holding power and is applicable for a single sheet of material through an amount of sheet material requiring full capacity for a given size embodiment.

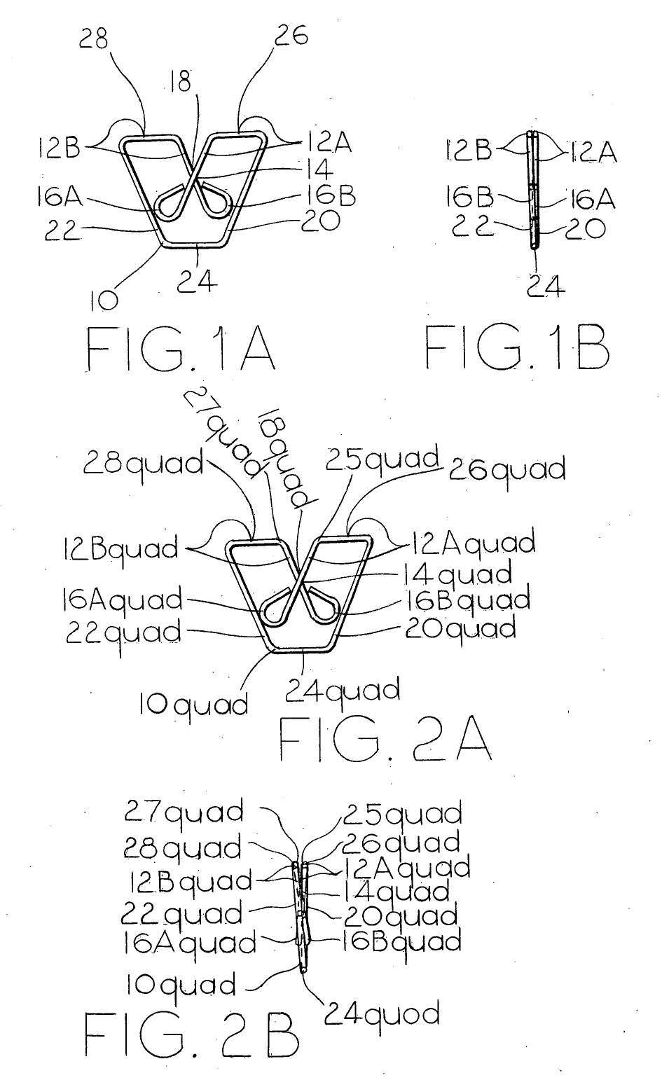

### DETAILED DESCRIPTION—SECOND EMBODIMENT—FIG. 2A, FIG. 2B

The overall structure of this embodiment is shown in FIG. 2A with middle portion 10quad having an overall substantial U shape and including spline 24quad, leg 20quad, and leg 22quad. Adjacent portion 12Aquad is connected to one end of middle portion 10quad. Adjacent portion 12Bquad is connected to an opposite end of middle portion 10quad. Adjacent portion 12Aquad (includes spline 26quad) bends inward and Adjacent Portion 12Bquad (includes spline 28quad) bends inward. Adjacent portions 12Aquad and 12Bquad overlap one another at overlapping point 14quad (FIG. 2A). Entry angle 18quad formed by adjacent portions 12Aquad and 12Bquad overlapping one another, side to side, is approximately 45 degrees in this embodiment. Adjacent portion 12Aquad continues past overlapping point 14quad but does not extend past middle portion 10quad, and end portion 16Aquad connects. End portion 16Aquad forms a loop. Adjacent portion 12Bquad continues past overlapping point 14quad but does not overlap middle portion 10quad, and end portion 16Bquad connects. End portion 16Bquad forms a loop. End portion loops 16Aquad, and 16Bquad do not overlap middle portion 10quad (FIG. 2A).

FIG. 2B shows a side view of this embodiment and comprising four substantial planes. FIG. 2A and FIG. 2B shows plane compositions and intersections for this four substantial plane composition. Leg 20quad, spline 24quad, and spline 26quad comprise a first substantial plane. Leg 22quad, spline 24quad, and spline 28quad comprise a second substantial plane. End portion 16Aquad, and adjacent portion 12Aquad (includes spline 26quad), comprise a third substantial plane. End portion 16Bquad and adjacent portion 12Bquad (includes spline 28quad), comprise a fourth substantial plane.

The first substantial plane and the second substantial plane intersect, and connect at spline 24quad. The first substantial plane and the third substantial plane intersect, and connect at spline 26quad. The second substantial plane and the fourth substantial plane intersect, and connect at spline 28quad. Thereby, middle portion 10quad comprises two substantial planes. Adjacent portions 12Aquad and 12Bquad bend toward each other, with bends 25quad and 27quad, respectively (FIG. 1B). This bending of adjacent portions is not only side to side, but front to back. End portion 16Aquad and adjacent portion 12Aquad, together, comprise a substantial plane. End portion 16B and adjacent portion 12B, together, comprise a substantial plane. Leg 20quad, adjacent portion 12Aquad, and end portion 16Aquad are spring loaded against leg 22quad, adjacent portion 12Bquad and end portion 16Bquad. This is through spline 24quad. An embodiment not being spring loaded is also satisfactory, however less powerful in clipping effects of FIG. 5A, FIG. 5C.

### Operation—The Second Embodiment, FIG. 5A-FIG. 5C

This embodiment operates basically the same as the first embodiment. However, increasingly stronger holding power is present with increasing angles between planes. For example, three degrees between the first and third substantial planes and three degrees between the second and fourth substantial planes is applicable. Slightly stronger holding power than the first embodiment is present in clipping effects of FIG. 5A, FIG. 5C. At seven degrees between the first and third substantial planes and seven degrees between the second and fourth substantial planes, significantly increased holding power is present in clipping effects of FIG. 5A, FIG. 5C. This angle, when as large as seven degrees, may cause significant paper dimpling on very small sheet material packets and may be an issue with clipping effects of FIG. 5A, FIG. 5C. However, this issue may be solved through distribution of clips in a variety of sizes per package. Usage of small or large clips depending on amount of sheet material is a solution. Small clips in this embodiment suit small amounts of sheet material satisfactory. Similarly, larger size clips are suitable for larger amounts of sheet material. Another solution is to use smaller diameter wire for a given size clip. This makes for an overall gentler yet dynamic embodiment, with this angular difference between planes.

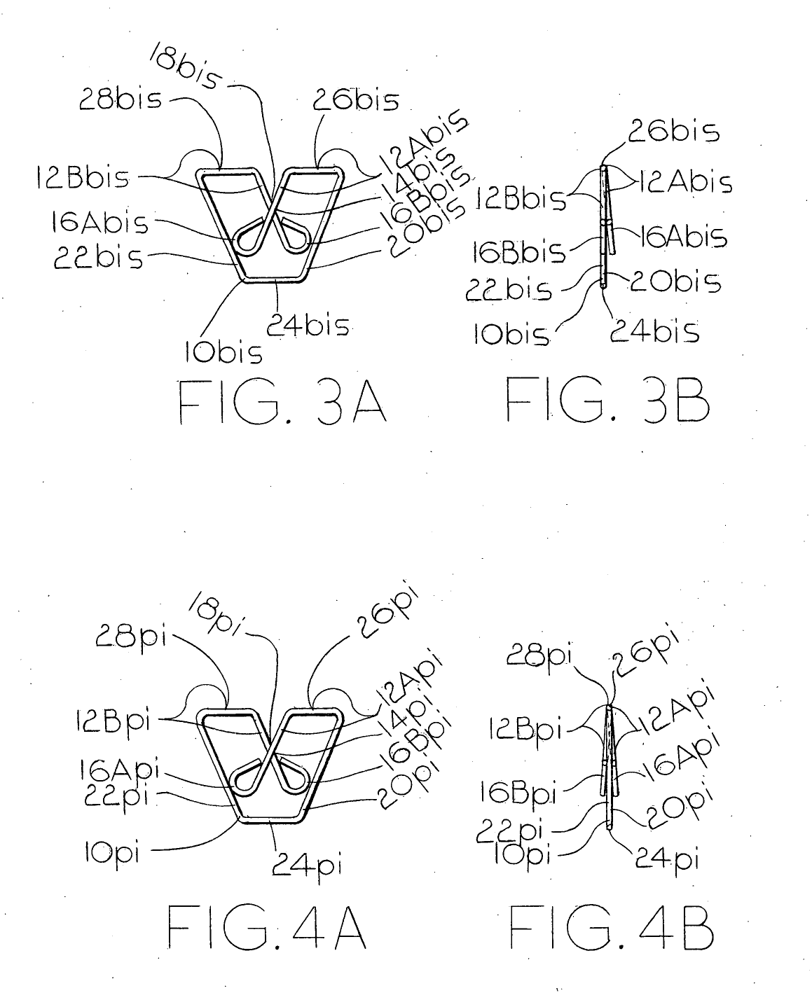

### DETAILED DESCRIPTION—THIRD EMBODIMENT—FIG. 3A, FIG. 3B

The overall structure of this embodiment is shown in FIG. 3A with middle portion 10bis having an overall substantial U shape and including spline 24bis, leg 20bis, and leg 22bis. Adjacent portion 12Abis is connected to one end of middle portion 10bis. Adjacent portion 12Bbis is connected to an opposite end of middle portion 10bis. Adjacent portion 12Abis (includes spline 26bis) bends inward and Adjacent Portion 12Bbis (includes spline 28bis) bends inward. Adjacent portions 12Abis and 12Bbis overlap one another at overlapping point 14bis. Entry angle 18bis formed by adjacent portions 12Abis and 12Bbis overlapping one another, side to side, is approximately 45 degrees in this embodiment. Adjacent portion 12Abis continues past overlapping point 14bis but does not extend past middle portion 10bis, and end portion 16Abis connects. End portion 16Abis forms a loop. Adjacent portion 12Bbis continues past overlapping point 14bis but does not overlap middle portion 10bis, and end portion 16Bbis connects. End portion 16Bbis forms a loop. End portion loops 16Abis, and 16Bbis do not overlap middle portion 10bis (FIG. 3A).

FIG. 3B shows adjacent portion 12Bbis with end portion 16Bbis in plane with middle portion 10bis and spline 26bis. This forms a first plane. Adjacent portion 12Abis with end portion 16Abis is forming a second substantial plane. The first and second substantial planes intersect at spline 26bis. Thereby, the third embodiment is forming another two substantial plane embodiment. Leg 20bis, adjacent portion 12Abis, and end portion 16Abis are spring loaded against leg 22bis, adjacent portion 12Bbis and end portion 16Bbis. This is through spline 24bis. An embodiment not being spring loaded is also satisfactory, however less powerful in clipping effects of FIG. 5A, FIG. 5C.

### Operation—Third Embodiment, FIG. 5A-FIG. 5C

This embodiment operates the same as the first embodiment.

### DETAILED DESCRIPTION—FOURTH EMBODIMENT—FIG. 4A, FIG. 4B

The overall structure of this embodiment is shown in FIG. 4A with middle portion 10pi having an overall substantial U shape and including spline 24pi, leg 20pi, and leg 22pi. Adjacent portion 12Api is connected to one end of middle portion 10pi. Adjacent portion 12Bpi is connected to an opposite end of middle portion 10pi. Adjacent portion 12Api (includes spline 26pi) bends inward and Adjacent Portion 12Bpi (includes spline 28pi) bends inward. Adjacent portions 12Api and 12Bpi overlap one another at overlapping point 14pi (FIG. 4A). Entry angle 18pi formed by adjacent portions 12Api and 12Bpi overlapping one another, side to side, is approximately 45 degrees in this embodiment. Adjacent portion 12Api continues past overlapping point 14pi but does not extend past middle portion 10pi, and end portion 16Api connects. End portion 16Api forms a loop. Adjacent portion 12Bpi continues past overlapping point 14pi but does not overlap middle portion 10pi, and end portion 16Bpi connects. End portion 16Bpi forms a loop. End portion loops 16Api, and 16Bpi do not overlap middle portion 10pi (FIG. 4A).

FIG. 4B shows middle portion 10pi, spline 26pi, and spline 28pi forming a first substantial plane. Adjacent portion 12Api (includes spline 26pi) with end portion 16Api is forming a second substantial plane. Adjacent portion 12Bpi (includes spline 28pi) with end portion 16Bpi is forming a third substantial plane. The first and second substantial planes intersect at spline 26pi. The first and third substantial planes intersect at 28pi. Leg 20pi, adjacent portion 12Api, and end portion 16Api are spring loaded against leg 22pi, adjacent portion 12Bpi and end portion 16Bpi. This is through spline 24pi. An embodiment not being spring loaded is also satisfactory, however less powerful in clipping effects of FIG. 5A, FIG. 5C.

### Operation—Fourth Embodiment, FIG. 5A-FIG. 5C

This embodiment operates the same as the First Embodiment.

### DETAILED DESCRIPTION—A Basic Rounded Embodiment—FIG. 7

The differences between this basic rounded embodiment and the first embodiment are as follows. Splines 24rnd, 26rnd, and 28rnd are rounded. Spline 24rnd is similar in width to the previous embodiments. However, spline 24rnd may be narrowed to only a single bend, front to back, center of middle portion. Where this embodiment lacks slightly in sheet material capacity, compared to The First Embodiment, it makes up for in user friendly feel. Fabric clipping is also applicable. This is a great one for kids too, because of the lack of sharp corners. Other basic rounded embodiments may be made in quad, bis, or pi, like the second, third, and fourth embodiment, respectively.

### Operation—Basic Rounded Embodiment, FIG. 5A-FIG. 5C

Operation of this basic rounded embodiment is the same as the first embodiment (FIG. 5A-FIG. 5C). Operations in quad, bis, or pi are like the second, third, and fourth embodiment, respectively.

### DETAILED DESCRIPTION—BASIC REVERSE LOOP EMBODIMENT—FIG. 8

The difference between a Basic Reverse Loop Embodiment and The First Embodiment is as follows. End portion loops 16Arvs; 16Brvs bend in reverse directions from the first embodiment. Splines 26rvs and 28rvs are squared at 90 degrees to legs 20rvs and 22rvs respectively. Entry angle 18rvs is approximately sixty degrees (FIG. 8). Other basic reverse loop embodiments may be made in quad, bis, or pi like the second, third, and fourth embodiment, respectively.

### Operation—Basic Reverse Loop Embodiment, FIG. 5A-FIG. 5C

This Basic reverse loop embodiment operates the same as the first embodiment (FIG. 5A-FIG. 5C).

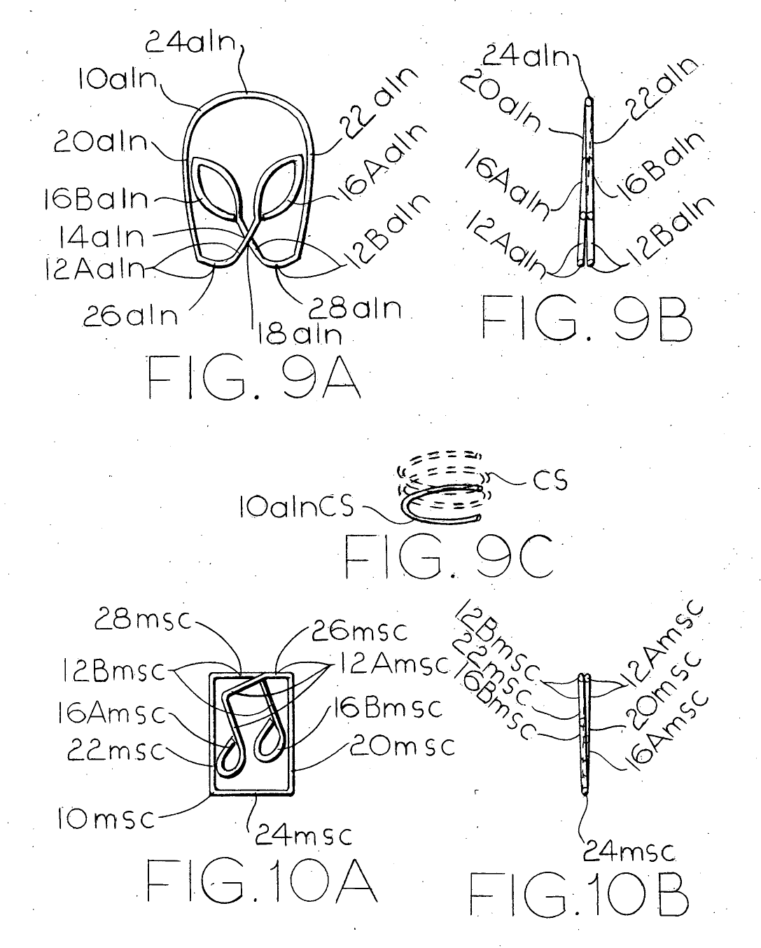

### DETAILED DESCRIPTION—AN ALIEN EMBODIMENT—FIG. 9A-FIG. 9C

The overall structure of this exemplary alien head embodiment in Free State is shown in FIG. 9A with middle portion 10aln having an overall substantial U shape and including rounded spline 24aln, rounded leg 20aln, and rounded leg 22aln. Adjacent portion 12Aaln is connected to one end of middle portion 10aln. Adjacent portion 12Baln is connected to an opposite end of middle portion 10aln. Adjacent portion 12Aaln bends inward and Adjacent Portion 12Baln bends inward. Adjacent portions 12Aaln and 12Baln overlap one another at overlapping point 14aln. Entry angle 18aln formed by adjacent portions 12Aaln and 12Baln overlapping one another, side to side, is approximately seventy degrees in this embodiment (FIG. 9A). Adjacent portion 12Aaln continues past overlapping point 14aln but does not extend past middle portion 10aln, and end portion 16Aaln connects. End portion 16Aaln forms a loop. Adjacent portion 12Baln continues past overlapping point 14aln but does not overlap middle portion 10aln, and end portion 16Baln connects. End portion 16Baln forms a loop. End portion loops 16Aaln, and 16Baln do not overlap middle portion 10aln (FIG. 9A). Rounded leg 20aln, adjacent portion 12Aaln, and end portion 16Aaln are spring loaded against rounded leg 22aln, adjacent portion 12Baln and end portion 16Baln. This is through rounded spline 24aln. An embodiment not being spring loaded is also satisfactory. Overlapping point 14aln is contiguous, although a noncontiguous overlapping point is also satisfactory.

FIG. 9B shows adjacent portion 12Aaln with end portion 16Aaln being in plane with leg 20aln and spline 24aln. These portions form a first substantial plane. Adjacent portion 12Baln with end portion 16Baln is in plane with leg 22aln and spline 24aln. This forms a second substantial plane and makes a two substantial plane embodiment. The first substantial plane and the second substantial plane intersect and connect at spline 24aln. Spline 24aln is similar in width to the first embodiment. However, spline 24aln may be narrowed to a single bend, front to back. This is center of middle portion where the first and second substantial planes intersect. Leg 20aln, adjacent portion 12Aaln, and end portion 16Aaln are spring loaded against leg 22aln, adjacent portion 12Baln and end portion 16Baln. This is through spline 24aln. An embodiment not being spring loaded is also satisfactory, however, less powerful in clipping effects of FIG. 5A, FIG. 5C. Rounded middle portion type embodiment middle portions may comprise a multitude of planes. Exemplary middle portion 10alnCS is like a section of coil spring CS (FIG. 9C). Other alien embodiments may be made in quad, bis, or pi, like the second, third, and fourth embodiments, respectively.

Operation—Alien embodiment, FIG. 5A-FIG. 5C

This alien embodiment operates the same as the first embodiment (FIG. 5A-FIG. 5C). See first embodiment for operation.

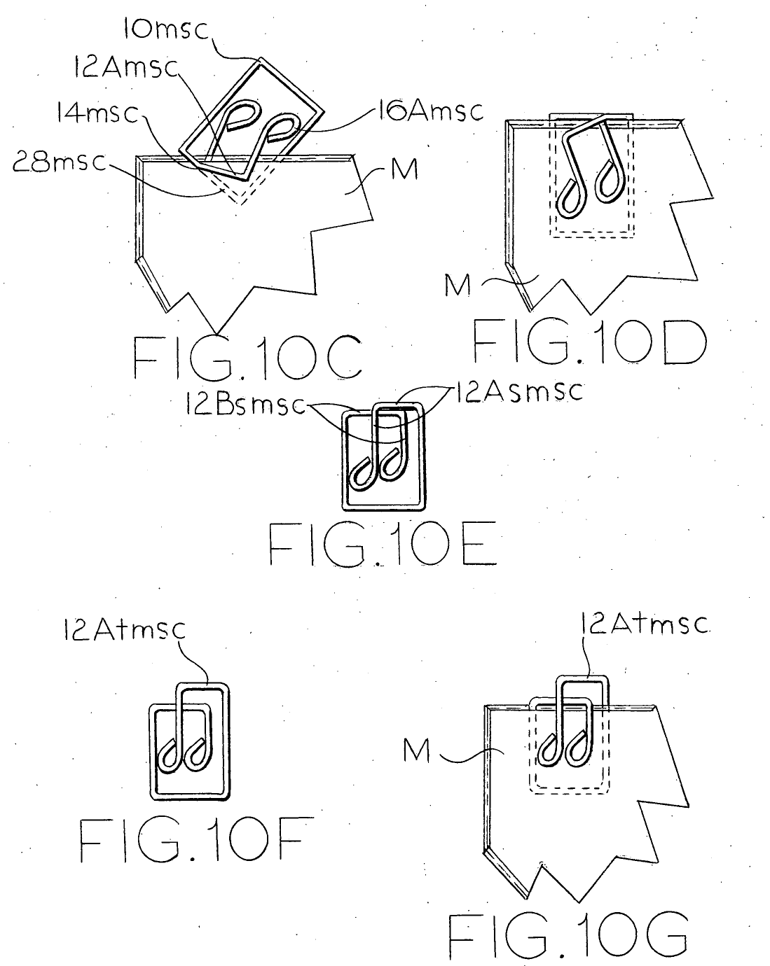

### DETAILED DESCRIPTION—A MUSIC NOTES EMBODIMENT—FIG. 10A, FIG. 10B

The overall structure of this exemplary music notes symbol embodiment is shown in Free State in FIG. 8A with middle portion 10msc having an overall substantial U shape and including spline 24msc, leg 20msc, and leg 22msc. Adjacent portion 12Amsc is connected to one end of middle portion 10msc. Adjacent portion 12Bmsc is connected to an opposite end of middle portion 10msc. Adjacent portion 12Amsc (includes spline 26msc) bends inward and Adjacent Portion 12Bmsc (includes spline 28msc) bends inward. Adjacent portion 12Amsc and adjacent portion 12Bmsc overlap one another at overlapping point 18msc. Adjacent portion 12Amsc continues past overlapping point 14msc but does not extend past middle portion 10msc, and end portion 16Amsc connects (FIG. 10A). End portion 16Amsc forms a loop. Adjacent portion 12Bmsc continues past overlapping point 14msc but does not overlap middle portion 10msc, and end portion 16Bmsc connects. End portion 16Bmsc forms a loop. End portion loops 16Amsc, and 16Bmsc do not overlap middle portion 10msc.

FIG. 10B shows adjacent portion 12Amsc with end portion 16Amsc being in plane with leg 20msc and spline 24msc. These portions form a first substantial plane. Adjacent portion 12Bmsc with end portion 16Bmsc is in plane with leg 22msc and spline 24msc. This forms a second substantial plane and makes a two substantial plane embodiment. The first substantial plane and the second substantial plane intersect and connect at spline 24msc. Leg 20msc, adjacent portion 12Amsc, and end portion 16Amsc are spring loaded against leg 22msc, adjacent portion 12Bmsc and end portion 16Bmsc. This is through spline 24msc. An embodiment not being spring loaded is also satisfactory, however, less powerful in clipping effects of FIG. 5A, FIG. 5C. Other music notes embodiments may be made in quad, bis, or pi, like the second, third, and fourth embodiments respectively.

### Operation—Music Notes Embodiment, FIG. 10B, FIG. 10C

An operative difference between this music notes embodiment and the first embodiment through fourth embodiment is the application as shown in FIG. 10C from direction of this embodiment. Instead of sheet material M edge being accepted at an overlapping point from this direction, one is accepted at a corner here. This corner is between middle portion 10msc and spline 28msc. The corner spreads away from adjacent portion 12Amsc and end portion 16Amsc as shown in FIG. 10C. Overlapping point 14msc spreads to accept sheet material M edge. Once applied, spline 24msc provides torsion. The application and clipping effect of FIG. 10D shows this recognizable music notes symbol on sheet material M. Other music notes embodiments made in quad, bis, or pi, operate like the second, third, and fourth embodiments, respectively.

### DETAILED DESCRIPTION—Squared Music Notes Embodiment—FIG. 10E

FIG. 10E shows a music notes symbol embodiment with adjacent portions 12Asmsc, 12Bsmsc made square to each other.

### Operation—Squared Music Notes Embodiment

This music notes embodiment operates the same as the previous music notes embodiment.

### DETAILED DESCRIPTION—Tabbed Music Notes Embodiment—FIG. 10F

FIG. 10F shows a music notes symbol embodiment with adjacent portion 12Atmsc forming a tab for easy removal from sheet material. Colored clips with a tab may also be used for document marking.

Operation—Tabbed Music Notes Embodiment—FIG. 10G

A difference in a Tabbed Music Notes embodiment is shown in FIG. 10G with one clipping effect leaving adjacent portion 12Atmsc as a tab protruding from sheet material M.

### DETAILED DESCRIPTION—A LION HEAD EMBODIMENT—FIG. 11

FIG. 11 shows an embodiment taking the shape of an animal head. Lion Head embodiments are made the same with regard to planes, as the first, second, third, and fourth embodiments.

Operation—Lion Head embodiments, FIG. 11

Lion head embodiments are the same as the first, second, third, and fourth embodiments with regard to operations.

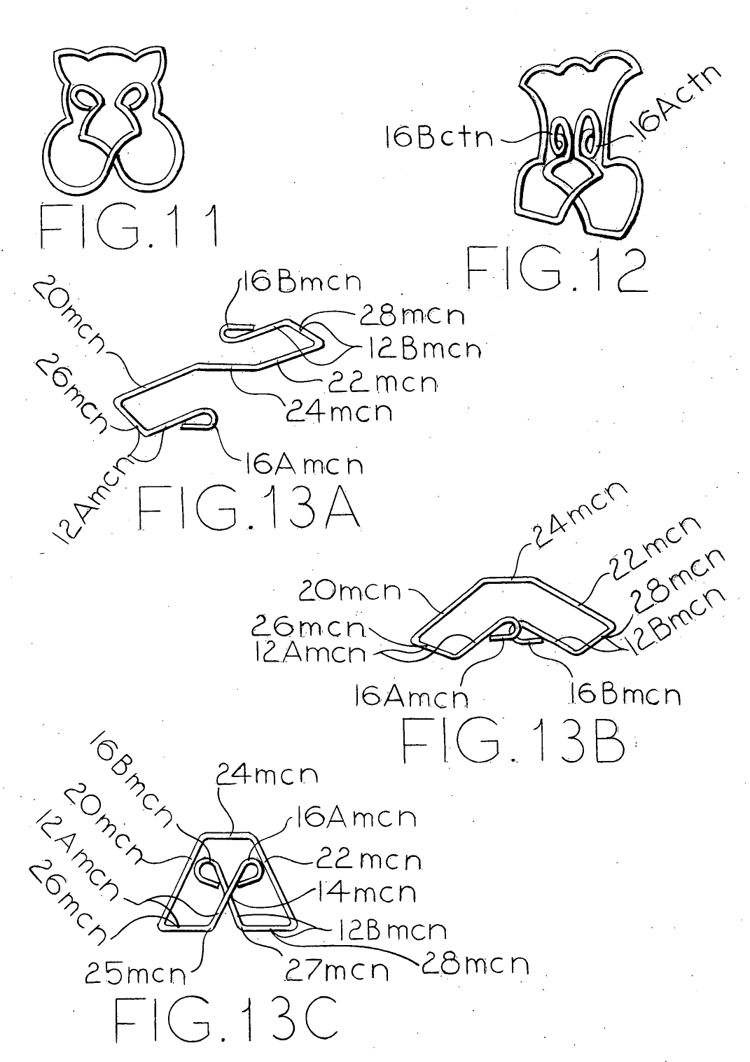

### DETAILED DESCRIPTION—A CARTOON CHARACTER EMBODIMENT—FIG. 12

This is an example of how an embodiment may be made asymmetrically. Symmetry is not necessary and asymmetry can produce a powerful perspective on a subject (FIG. 12). End portion loops may be different sizes with respect to each other, as shown here with end portion 16Actn and end portion 16Bctn. Each end portion may comprise a plurality of substantial loops as shown here with end portion 16Actn and end portion 16Bctn (FIG. 12). Cartoon character embodiments are made the same with regard to planes, as the first, second, third, and fourth embodiments.

### Operation—Cartoon Character Embodiment, FIG. 12

Cartoon character embodiments are the same as the first, second, third, and fourth embodiments with regard to operations.

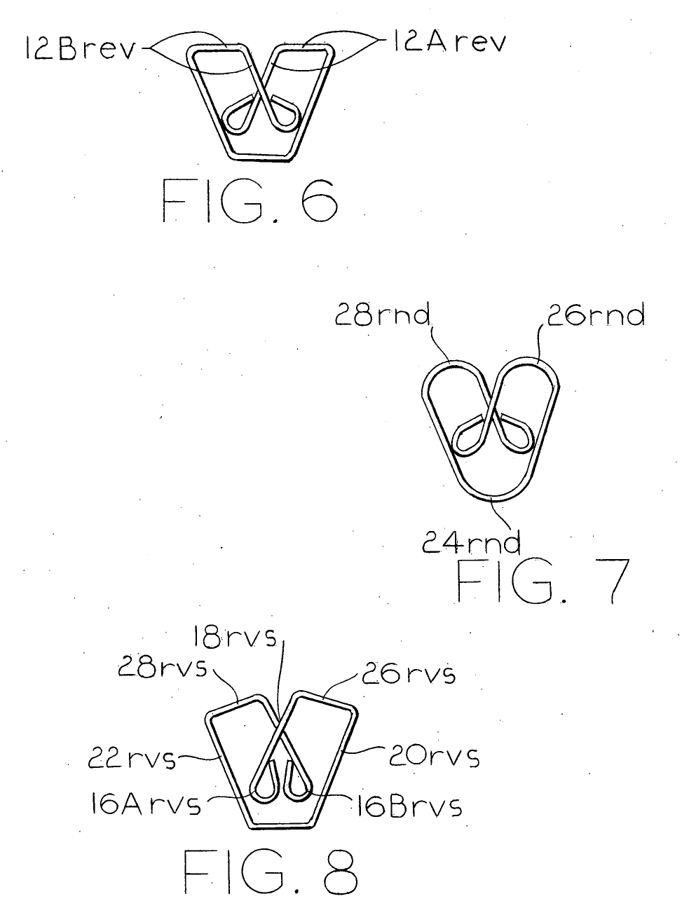

### DETAILED DESCRIPTION—REVERSE OVERLAPPING POINT EXAMPLE—FIG. 6

A reverse overlapping point may be made in any embodiment. FIG. 6 shows a reverse overlapping point embodiment with adjacent portion 12Brev bending inward, thereby overlapping over adjacent portion 12Arev. Note this is the reverse overlapping point of all other figures.

### Operation—Reverse Overlapping Point Example, FIG. 6, FIG. 5A-FIG. 5C

Embodiments made with a reverse overlapping point are the same as the first, second, third, and fourth embodiments with regard to operations. The only difference is a mirror image look is present in clipping effects once applied.

### MACHINING—FIG. 13A-FIG. 13C, FIG. 1B, FIG. 2B, FIG. 3B, FIG. 4B

FIG. 13A shows a first step in bending of a wire strand with end portion loop 16Amcn, adjacent portion 12Amcn, leg 20mcn, and spline 24mcn planing on a level plane. End portion loop 16Bmcn, adjacent portion 12Bmcn and leg 22mcn are bent and planing on a plumb plane. This makes a 90 degree angle between level portions and plumb portions. More or less than a ninety degree angle difference will result in more or less of a spring loaded strength. Angles all the way down to zero degrees making for no spring loading as well as angles more than ninety degrees making for extra strong spring loading are also found satisfactory. To spring load this embodiment, bend as follows. Bring the plumb portions (end portion 16Bmcn, adjacent portion 12Bmcn (includes spline 28mcn), leg 22mcn) down to the level planing portions (end portion 16Amcn, adjacent portion 12Amcn (includes spline 26mcn), spline 24mcn) by bending between spline 24mcn and leg 22mcn. Overlap end portion loops 16Amcn, 16Bmcn as shown in FIG. 13B. Complete bends between spline 24mcn and legs 20mcn, 22mcn until overlapping point 14mcn is in place, side to side. This brings adjacent portions together, forming contiguous overlapping point 14mcn and two substantial planes. One can stop here and have a two substantial plane or a three substantial plane spring loaded embodiment, planing as shown in FIG. 1B, FIG. 3B, or FIG. 4B. A slight bending of adjacent portions 12Amcn, 12Bmcn towards each other, front to back, with bends 25mcn and 27mcn will result in a four substantial plane embodiment. This is the planar composition of FIG. 2B.

### Advantages

Many advantages are apparent for the present wire clip embodiments. Possibly the greatest advantage is the novel, innovative nature, which brings consumer excitement and status providing the manufacturer with markup ability. Multiple target groups, including youth market, the music industry, and executive are practical. This is due to fads, natural images, classic symbols, and interesting operations. Clips are easy to apply, have increased or similar capacity over prior art, long lasting, reversible with multiple functions, more powerful, and fully developed. Little learning is required by the consumer, and consumers are likely to find some functions and features on their own. These clips are easy to promote through magazines, racks in the front of stores, conventions, promotional giveaways, etc. A good product will also sell itself, and these embodiments are the most versatile, powerful, and improved wire clips ever. Finally, multiple industries are applicable with the paper clip, money clip, and all purpose clip industries.

### CONCLUSION, RAMIFICATION, SCOPE

Thus the reader will see that at least one embodiment of the clip provides a more powerful, more adjustable, most reversible, yet economical device that can be used by persons of almost any age. While my above description contains much specificity, these should not be construed as limiting the scope of the embodiment but rather as merely providing illustrations of some of the presently preferred embodiments. For example, an embodiment can have other shapes, such as square, rectangular circular, oval, trapezoidal, etc. A clip can take the shape of a skull, logo, and heads with sunglasses on, happy faces and about anything where loops and an overlapping point can be incorporated. End portion loops can have other shapes such as square, circular, oval, rectangular, trapezoidal, etc.

Thus the scope of the embodiment should be determined by the appended claims and their legal equivalents, rather than by the examples given.

Uses for all purpose clip sizes and marketing include paper and plastic bag closure, securing mail together, book marking, securing newspapers, and just about any material with appropriate thickness for a size of a clip. Marketing and economics for money clip applications, and the use of spring steel or the like, allow for a multitude of embodiments. Marketing of embodiments as paper clips, money clips, and all purpose clips are foreseen as the greatest opportunities.

Sizes of an embodiment have a wide range of sizes. A smallest size is about three eighths inch for spline 24, by about five eighths inch for each of leg 20 and leg 22 (FIG. 1A). Wire diameters for this small size range from light to heavy. A light diameter wire for this size of an embodiment is about one half millimeter. A heavy diameter wire for this size of an embodiment is about one millimeter. A large size of the first embodiment is about one and one half inch for spline 24, by about two and one half inch for each of leg 20 and Leg 22 (FIG. 1A). Wire diameters for this large size of an embodiment range from light to heavy. A light diameter wire for this size of an embodiment is about one and one quarter millimeter. A heavy diameter wire for this size of an embodiment is about two and one half millimeter. Heretofore, wire is indicating standard chrome paperclip wire bendable and when bent remains in the bent position. Wire rigidity ranges from pliable copper to spring steel. Other techniques known to the industry such as flattening copper wire to achieve more rigidity may be implemented. The more rigid a wire is, the less a wire diameter has to be to have the same effect. Other wire known to the industry such as black, white, or colored plastic coated or vinyl coated is also satisfactory. Embodiments made of spring steel or other wire bendable and when bent returns to an original position are also applicable for paperclips, money clips and all purpose clips. This type of material allows an embodiment to keep a shape and have extended life. A money clip, all purpose clip, as with a paper clip, formed of wire bendable, and when bent remains in the bent position is also satisfactory. Wire may be metallic, composite, plastic or vinyl coated, painted, or other known to the industry.

I claim:

1. A clip formed of a pre-determined length of wire providing reversibility from at least two opposing directions with a plurality of clipping effects, and means for a plurality of substantially different holding power strengths to at least one amount of sheet material.

2. The clip of claim 1 wherein a middle portion is forming an overall substantial U shape and at least one plane.

3. The clip of claim 1 wherein two adjacent portions, each one to an opposite end of said middle portion, are bending inward toward an interior, thereby overlapping one another, and neither one are overlapping said middle portion.

4. The clip of claim 1 wherein two end portions, one to each of said adjacent portions, are each forming at least one loop, and neither one are overlapping said middle portion.

5. The clip of claim 1 wherein each one of said end portions, with each one of respective said adjacent portions, are forming a plane.

6. The clip of claim 1 wherein one of said adjacent portions is spring loaded against the other one of said adjacent portions through said middle portion.

7. The clip of claim 6 wherein means for increased holding power is present with at least one clipping effect.

8. The clip of claim 1 wherein a symbol is depicted in Free State and in a clipping effect.

9. The clip of claim 1 wherein a cartoon character is depicted in Free State.

10. The clip of claim 1 wherein an animal head in depicted in Free State.

11. The clip of claim 1 wherein an alien head is depicted in Free State.
whereby a human can work, read, travel, and enjoy secured papers or the like.
